(19) United States
(12) Patent Application Publication
(10) Pub. No.: US 2014/0207386 A1
(43) Pub. Date: Jul. 24, 2014

(54) METHOD AND APPARATUS OF ALIGNING A READ SEQUENCE

(71) Applicant: Electronics and Telecommunications Research Institute, Daejeon (KR)

(72) Inventors: Ho-Youl JUNG, Daejeon (KR); Minho KIM, Daejeon (KR); Myung-eun LIM, Daejeon (KR); Jae Hun CHOI, Daejeon (KR); Soo Jun PARK, Seoul (KR)

(21) Appl. No.: 13/940,182

(22) Filed: Jul. 11, 2013

(30) Foreign Application Priority Data
Jan. 18, 2013 (KR) 10-2013-0006021

(51) Int. Cl. G06F 19/22

(52) U.S. Cl. CPC G06F 19/22
USPC 702/20

(57) ABSTRACT

Provided are a method of aligning a read sequence relative to a reference sequence using a seed and a read-sequence aligning apparatus using the same. The apparatus may include a seed generating unit producing seeds from read sequences, a representative seed selecting unit grouping the seeds into a plurality of seed clusters and selecting representative seeds from the plurality of seed clusters, a seed aligning unit aligning the representative seeds relative to a reference sequence, and a read-sequence aligning unit aligning the read sequences relative to the reference sequence, with reference to the alignment result of the representative seeds. The read sequence alignment may be performed using relationship between seeds, and thus, the sequencing may be performed with improved efficiency.

### CROSS-REFERENCE TO RELATED APPLICATIONS

This U.S. non-provisional patent application claims priority under 35 U.S.C. §119 to Korean Patent Application No. 10-2013-0006021, filed on Jan. 18, 2013, in the Korean Intellectual Property Office, the entire contents of which are hereby incorporated by reference.

### BACKGROUND OF THE INVENTION

Example embodiments of the inventive concept relate to method and apparatus of aligning a read-sequence, and in uniticular, to a method of aligning a read sequence relative to a reference sequence using a seed and a read-sequence aligning apparatus using the same.

In a next-generation sequencing (NGS), a genome to be sequenced is cut to produce read sequences, which may constitute a library. The read sequences may be amplified and be aligned relative to a reference sequence (e.g., the known sequence of human genome). By comparing the aligned read sequence with the reference sequence, it is possible to detect a gene mutation or a variant letter.

To align the read sequences relative to the reference sequence, seeds may be produced from the read sequences. The produced seeds may be aligned relative to the reference sequence, and the read sequences may be aligned with reference to the aligned seed.

However, when compared with the reference sequence, the number of read sequences for NGS is very large, although a size of the read sequence is small. In addition, the number of the seeds may be larger than that of the read sequences. Accordingly, there is an increasing demand for a method capable of aligning the read sequences through reduced operation steps.

### SUMMARY

Example embodiments of the inventive concept provide a method and an apparatus of aligning a read sequence with improved efficiency.

According to example embodiments of the inventive concepts, a read-sequence aligning apparatus may include a seed generating unit producing seeds from read sequences, a representative seed selecting unit grouping the seeds into a plurality of seed clusters and selecting representative seeds from the plurality of seed clusters, a seed aligning unit aligning the representative seeds relative to a reference sequence, and a read-sequence aligning unit aligning the read sequences relative to the reference sequence, with reference to the alignment result of the representative seeds.

In example embodiments, the seed generating unit may be configured to produce the seeds having a predetermined specific length.

In example embodiments, the representative seed selecting unit may be configured to group the seeds into the plurality of the seed clusters, on the basis of an edit distance.

In example embodiments, the grouping of the seeds may be performed in such a way that the seeds in each seed cluster have an edit distance that may be less than a predetermined critical value.

In example embodiments, the predetermined critical value may be 1.

In example embodiments, the representative seed selecting unit may be configured to select the representative seed from the plurality of the seed clusters, on the basis of the edit distance.

In example embodiments, the selecting of the representative seed may be performed in such a way that the representative seed for each seed cluster may be selected to be one, having an intermediate value, of the seeds in each seed cluster.

In example embodiments, the seed aligning unit may be configured to align the representative seeds relative to the reference sequence, under a condition that a predetermined number of mismatching may be allowed.

In example embodiments, the apparatus may further include a seed-information storing unit storing information on each of the seeds in the seed clusters. The information on each of the seeds may include information on a position of a read sequence containing each seed and information on a position of each seed relative to the read sequence, and the read-sequence aligning unit aligns the read sequences relative to the reference sequence, with reference to the information on each seed and an align result of the representative seeds.

According to example embodiments of the inventive concepts, a method of aligning a read-sequence may include producing seeds from read sequences, grouping the seeds into a plurality of seed clusters, selecting representative seeds from the seed clusters, respectively, aligning the selected representative seeds relative to a reference sequence, and aligning the read sequences relative to the reference sequence, with reference to the alignment result of the representative seeds.

In example embodiments, the grouping of the seeds may be performed in such a way that the seeds in each seed cluster have an edit distance that may be less than a predetermined critical value.

In example embodiments, the representative seeds may be selected in such a way that an edit distance from other seeds in each seed cluster may be the minimum.

In example embodiments, the aligning of the read sequences may include selecting candidate positions of the read sequences with reference to the alignment result of the representative seeds, and performing a similarity local alignment to the candidate positions of the read sequences. The similarity local alignment may be calculated under a condition that a predetermined number of mismatching may be allowed.

In example embodiments, the similarity local alignment may be performed using Smith-Waterman algorithm.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a block diagram showing a read-sequence aligning apparatus.

FIG. 2 is a diagram provided to describe in detail an operation of the read-sequence aligning apparatus shown in FIG. 1.

FIG. 3 is a block diagram illustrating a read-sequence aligning apparatus according to example embodiments of the inventive concept.

FIG. 4 is a diagram provided to describe an operation of the seed generating unit of FIG. 3.

FIG. 5 is a diagram provided to describe an operation of the representative seed selecting unit of FIG. 3.

FIG. 6 is a diagram provided to describe an operation of the read-sequence aligning unit of FIG. 3.

FIG. 7 is a flow chart illustrating a read-sequence aligning method according to example embodiments of the inventive concept.

FIG. 8 is a flow chart exemplarily illustrating a method of aligning the read sequence with reference to a representative-seed mapping result shown in FIG. 7.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

The terminology used herein is for the purpose of describing uniticular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

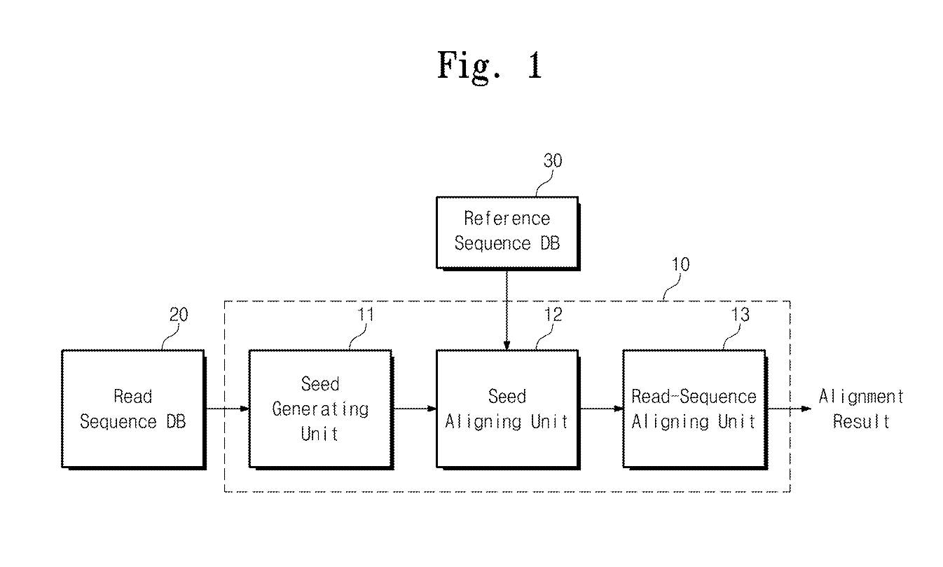

FIG. 1 is a block diagram showing a read-sequence aligning apparatus. Referring to FIG. 1, a read-sequence aligning apparatus 10 may include a seed generating unit 11, a seed aligning unit 12, and a read-sequence aligning unit 13.

The seed generating unit 11 may receive read sequences from a read sequence data base (DB) 20. The read sequence DB 20 may be configured to store the read sequences that are prepared by cutting a genome to be deciphered into short pieces.

The read sequences may be produced by a next-generation sequencing machine (NGS Machine). The read sequences may be aligned by amplifying and comparing them with the reference sequence. In general, a total length of the amplified read sequences may be about 30 times longer than a length of the reference sequence. This means that the total length of the read sequence sets required to decipher the whole human genome may be more than 90 billion bases. However, an amount of the read sequences to be amplified may not be limited thereto.

The seed generating unit 11 may be configured to produce a seed, whose length is constant, from each of the read sequences. The seed may be a short piece that is a portion of the read sequence. In example embodiments, a plurality of the seeds may be produced from a read sequence. The seeds produced by the seed generating unit 11 may be transmitted to the seed aligning unit 12.

The seed aligning unit 12 may receive the seeds from the seed generating unit 11. Further, the seed aligning unit 12 may receive the reference sequence from the reference sequence DB 30. The seed aligning unit 12 may be configured to align the seeds relative to the reference sequence.

The reference sequence may be used as a reference, to which the pieces of genome are compared. To decipher wholly a genome of a person, the human genome having about 3 billion bases may serve as the reference sequence. Information on the seed alignment relative to the reference sequence may be transmitted from the seed aligning unit 12 to the read-sequence aligning unit 13.

The read-sequence aligning unit 13 may be configured to align the read sequences relative to the reference sequence, with reference to the seed alignment information. The read-sequence aligning unit 13 may output an alignment result of the read sequence relative to the reference sequence.

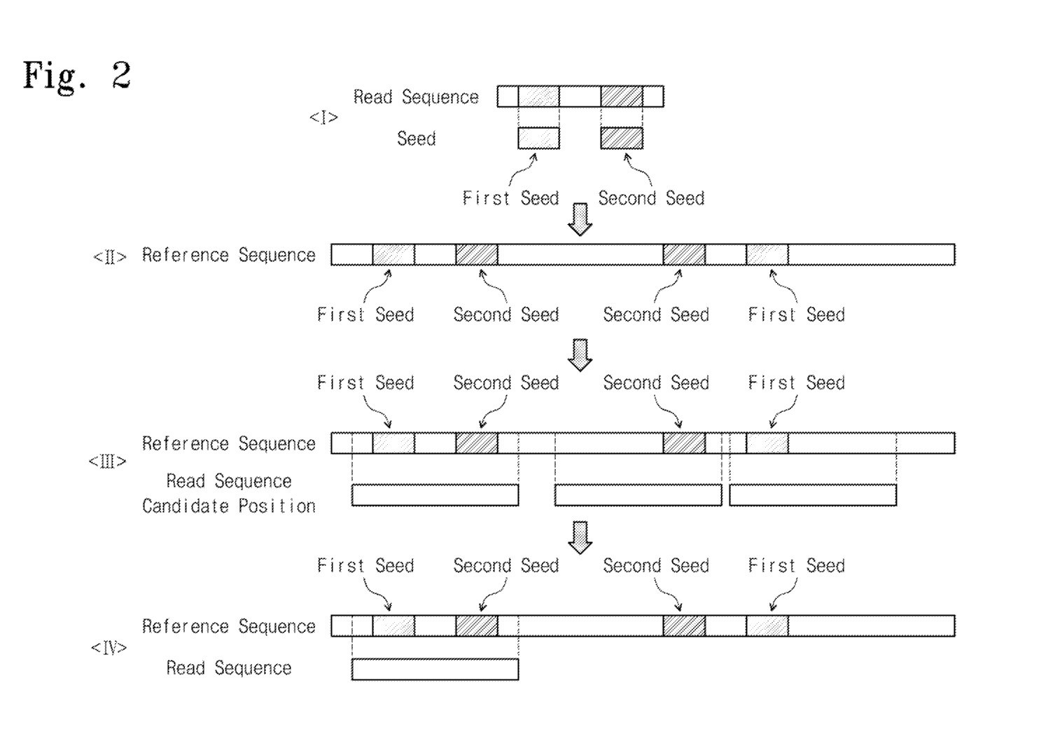

FIG. 2 is a diagram provided to describe in detail an operation of the read-sequence aligning apparatus shown in FIG. 1. For the sake of brevity, the description that follows will refer to an example related to one of the read sequences.

In step <I>, seeds may be produced from a read sequence. For example, as shown in FIG. 2, a first seed and a second seed may be produced from read sequence. A length and the number of the seed to be produced may not be limited thereto. For a subsequent aligning operation, information on identification and position of the read sequence including the first and second seeds may be stored.

In step <II>, the first and second seeds produced in the step <I> may be aligned relative to the reference sequence. In example embodiments, portions of the reference sequence that are matched with each of the seeds within a specific error range may be searched. A plurality of unitial sequences for each seed may be searched.

In step <III>, candidate positions of the read sequence may be selected with reference to the seeds aligned in the step <II>. For example, positions of unitial sequences, in which the first and second seeds are included within a specific distance, may be selected as the candidate positions of the read sequence. Alternatively, positions of unitial sequences, in which the first seed or the second seed is included, may be selected as the candidate positions of the read sequences.

In step <IV>, calculation may be performed to see whether the read sequence is matched at the candidate positions selected in the step <III>. The calculation of the matching may be performed by comparing the read sequence with the remaining of the base sequences, except the matched seed. The read sequence may be aligned based on the result of the calculation.

The read-sequence aligning apparatus 10, described with reference to FIGS. 1 and 2, may perform a read-sequence aligning process using a seed. As the result of the use of the seed, it is possible to perform the read-sequence aligning process with increased efficiency, when compared with the method of mapping each read sequence.

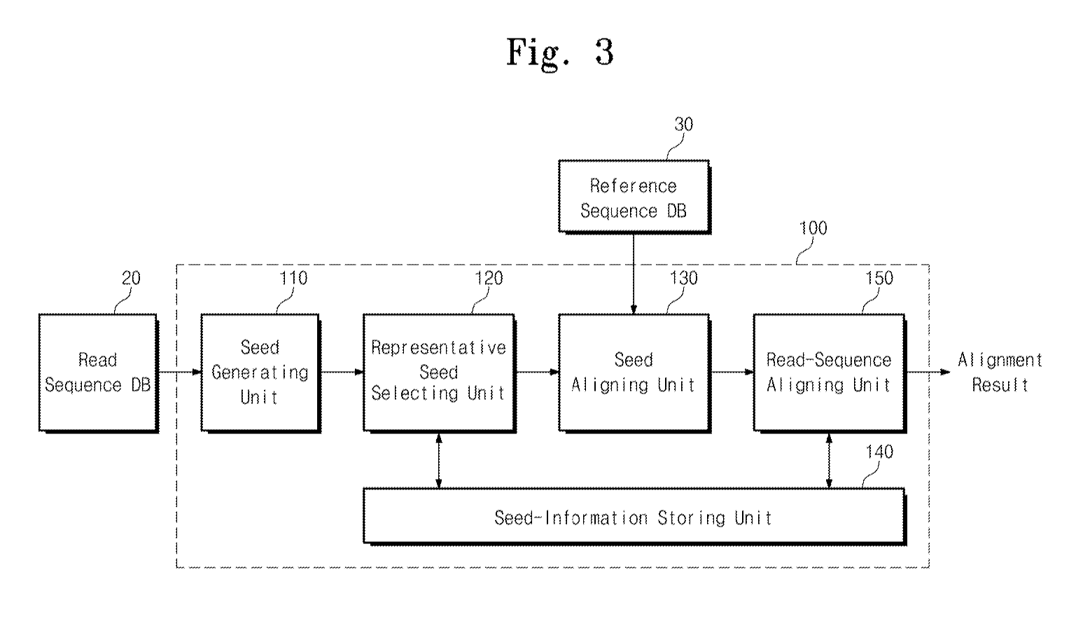

FIG. 3 is a block diagram illustrating a read-sequence aligning apparatus 100 according to example embodiments of the inventive concept. Referring to FIG. 3, the read-sequence aligning apparatus 100 may include a seed generating unit 110, a representative seed selecting unit 120, a seed aligning unit 130, a seed-information storing unit 140, and a read-sequence aligning unit 150.

The read-sequence aligning apparatus 100 may be configured to group at least one seed produced from the read sequences into a plurality of seed clusters and perform an aligning process on representative seeds that are selected from the seed clusters, respectively. The read-sequence aligning apparatus 100 may be configured to avoid a duplicated calculation in consideration of similarity between the seeds, and this makes it possible to perform operations with efficiency.

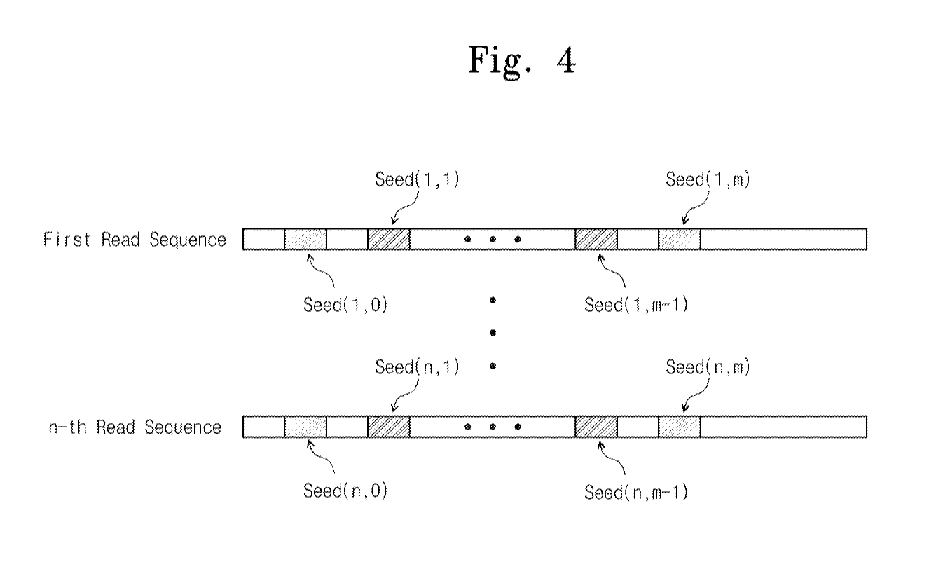

The seed generating unit 110 may be configured to have substantially the same configuration or operational principle as the seed generating unit 11 of FIG. 1. The seed generating unit 110 may receive read sequences from the read sequence DB 20. The seed generating unit 110 may produce seeds having a specific length from each of the received read sequences. The seeds produced from the seed generating unit 110 may be provided to the representative seed selecting unit 120. An operation of the seed generating unit 110 will be described in more detail with reference to FIG. 4.

The representative seed selecting unit 120 may be configured to perform an operation of grouping the seeds provided from the seed generating unit 110 into a plurality of seed clusters. The representative seed selecting unit 120 may group the seeds in consideration of relationship between the seeds. For example, the representative seed selecting unit 120 may group the seeds based on an edit distance. The representative seed selecting unit 120 may be configured to group the seeds into seed clusters, wherein each of the seed clusters have edit distance less than a predetermined critical value (e.g., 1), but example embodiments of the inventive concepts may not be limited thereto.

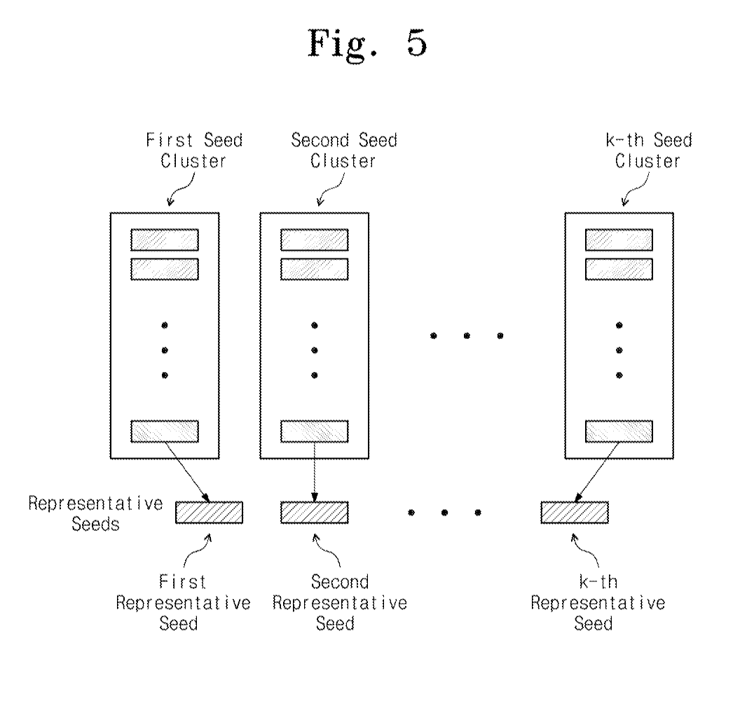

The representative seed selecting unit 120 may select a representative seed from each seed cluster. In example embodiments, the representative seed may be selected in such a way that the edit distance from other seeds is smallest in each seed cluster, but example embodiments of the inventive concepts may not be limited thereto. The representative seed selecting unit 120 may provide the selected representative seed to the seed aligning unit 130. An operation of the representative seed selecting unit 120 will be described in more detail with reference to FIG. 5.

The seed aligning unit 130 may be configured to have substantially the same configuration or operational principle as the seed aligning unit 12 of FIG. 1. The seed aligning unit 130 may receive the representative seeds from the representative seed selecting unit 120. Further, the seed aligning unit 130 may receive the reference sequence from the reference sequence DB 30. The seed aligning unit 130 may align the provided representative seeds relative to the reference sequence.

The seed-information storing unit 140 may store information on the seeds contained in the seed clusters. Information on the seeds, which may be stored in the seed-information storing unit 140, may contain information on the read sequence containing the seeds.

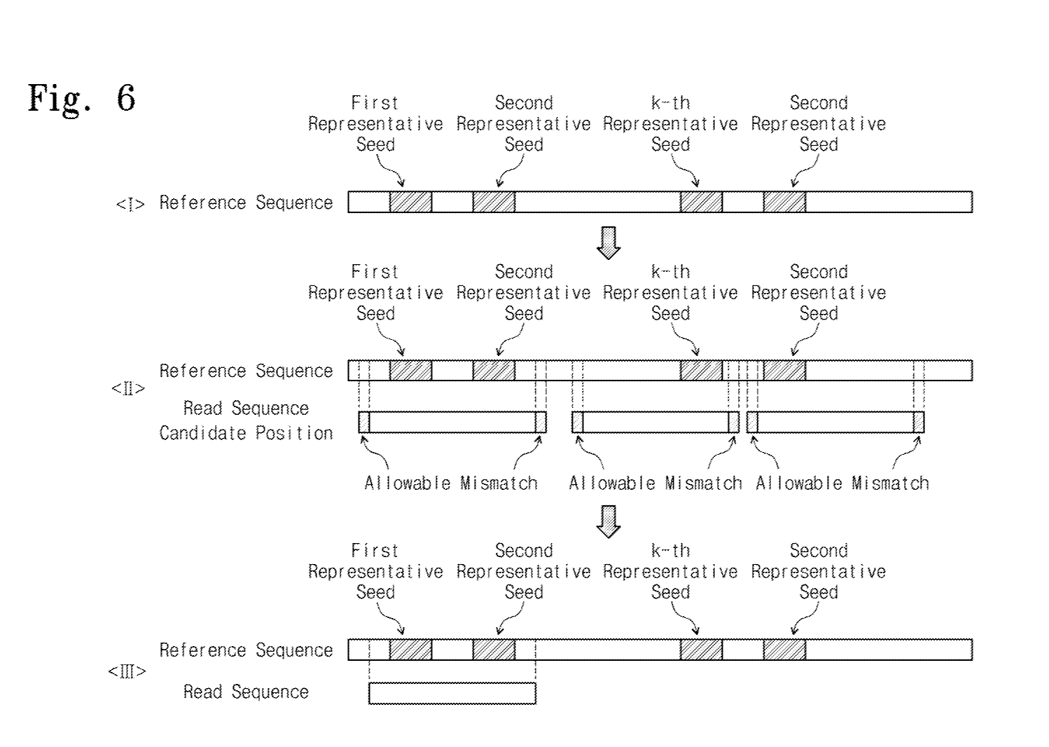

The read-sequence aligning unit 150 may refer to the representative seed aligned by the seed aligning unit 130 to align the read sequences relative to the reference sequence. The read-sequence aligning unit 150 may output the result of the alignment of the read sequences relative to the reference sequence. The alignment of the read sequences by the read-sequence aligning unit 150 will be described in more detail with reference to FIG. 6.

According to example embodiments of the inventive concept, the read-sequence aligning apparatus 100 may perform an operation of grouping a seed produced from read sequences into a plurality of seed clusters, and then, perform an aligning operation to only representative seeds that are selected from each of the seed clusters. The read-sequence aligning apparatus 100 may be configured to avoid a duplicated calculation in consideration of similarity between the seeds, and this makes it possible to perform operations with efficiency.

FIG. 4 is a diagram provided to describe an operation of the seed generating unit of FIG. 3. Referring to FIG. 4, the seed generating unit 110 may be configured to produce seeds from n read sequences.

The seeds may be produced by dividing each read sequence into a plurality of base sequences with a predetermined length. Alternatively, the seeds may be produced by dividing each read sequence into a plurality of base sequences with a predetermined length and an overlapping region. However, the method of producing the seed from the read sequence is not limited to the above methods.

For the sake of brevity, in the present embodiment, let us suppose that m+1 seeds are produced from each read sequence. In other words, m+1 seeds (seed[1,0:m]) may be produced from a first read sequence. Similarly, m+1 seed (seed ([n, 0:m]) may be produced from a n-th read sequence. Accordingly, the seed generating unit 110 may produce n X (m+1) seeds from n read sequences. However, example embodiments of the inventive concept are not limited to the example, in which the number of the seeds to be produced from each read sequence is constant. The seed generating unit 110 may provide the seeds to the representative seed selecting unit 120.

FIG. 5 is a diagram provided to describe an operation of the representative seed selecting unit of FIG. 3. Referring to FIG. 5, the representative seed selecting unit 120 may group the seeds into a plurality of seed clusters and select a representative seed from each seed cluster.

In the representative seed selecting unit 120, the grouping of the seeds may be performed based on an edit distance. For example, the representative seed selecting unit 120 may be configured to calculate all of pairwise edit distances between the seeds. In the representative seed selecting unit 120, the calculation result may be used to group the seeds, whose edit distance is less than a predetermined critical value, and thereby form the seed clusters. The number of the seed clusters to be produced and the number of the seeds in each cluster may be dependent on relationship between the seeds. In example embodiments, the seeds in each cluster may be produced from different read sequences.

The representative seed selecting unit 120 may select representative seeds from the seed clusters. In example embodiments, one representative seed may be selected from each seed cluster. The representative seed may be one, having an intermediate value, of the seeds in each seed cluster. For example, the representative seed may be selected in such a way that an edit distance from other seeds in the seed cluster is the minimum. The representative seed selecting unit 120 may provide the selected representative seeds to the seed aligning unit 130.

Information on the seeds in each seed cluster may be stored in the seed-information storing unit 140. The seed-information storing unit 140 may store information on the read sequence containing the seeds and information on positions of the seeds relative to the corresponding read sequence.

FIG. 6 is a diagram provided to describe an operation of the read-sequence aligning unit of FIG. 3. Referring to FIG. 6, the read-sequence aligning unit 150 may align the read sequences with reference to the aliment result of the representative seeds.

In step <I>, an aliment result of first to k-th representative seeds relative to the reference sequence may be provided from the seed aligning unit.

In step <II>, candidate positions of the read sequence may be selected with reference to the aliment result of the representative seeds referenced in the step <I>. If the representative seed is matched with a unitial sequence of the reference sequence, all of the seeds in the seed cluster containing the representative seed may be regarded to be matched. In other words, all seeds contained in the first seed cluster may be regarded to be matched, at a matching position of the first representative seed.

The read-sequence aligning unit 150 may refer to information on the seed cluster and the seeds stored in the seed-information storing unit 140 to select candidate positions for the read sequence. For example, if there is a read sequence including two seeds that are contained in the first and second seed clusters, respectively and are located within a predetermined distance, positions of unitial sequences, in which the first and second representative seeds are located within a predetermined distance, may be selected as the candidate positions for the read sequence. The number of the candidate positions for the read sequence may be increased in consideration of possibility of mismatching.

In step <III>, calculation may be performed to see whether the read sequence is matched at the candidate positions selected in the step <II>. The calculation of the matching may be performed by comparing the read sequence with the remaining of the base sequences, except the matched seed. The calculation of the matching may be allowed to be mismatched by a predetermined number of times. For example, the calculation of the matching may be performed using Smith-Waterman algorithm. In example embodiments, the calculation of the matching may be performed by scoring a degree of similarity. The read sequence may be aligned based on the result of the calculation.

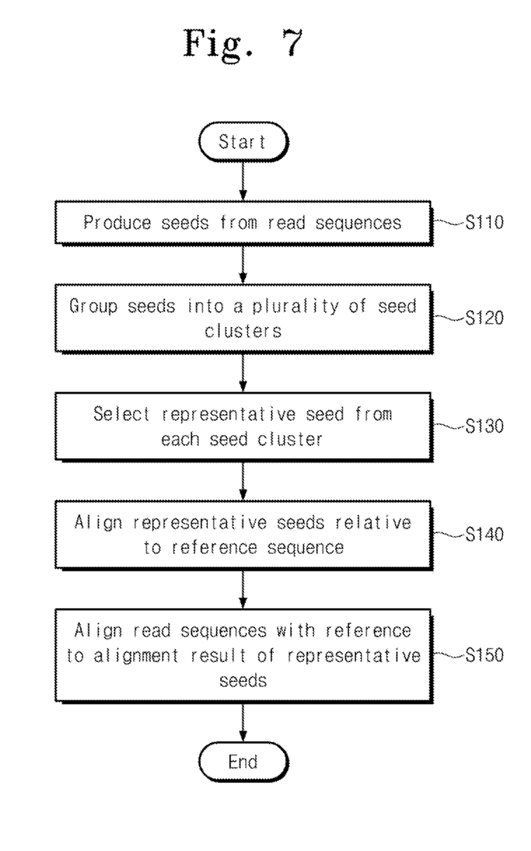

FIG. 7 is a flow chart illustrating a read-sequence aligning method according to example embodiments of the inventive concept. The read-sequence aligning method according to example embodiments of the inventive concept may be performed to avoid a duplicated calculation in consideration of similarity between the seeds, and this makes it possible to perform operations with efficiency.

In step S110, seeds may be produced from read sequences. Lengths and the number of the seeds to be produced from the read sequences may not be limited.

In step S120, the produced seeds may be grouped into a plurality of seed clusters. The grouping of the seeds may be performed based on an edit distance. In example embodiments, the seeds in each seed cluster may have an edit distance that is less than a predetermined critical value.

In step S130, a representative seed may be selected from each seed cluster. The representative seed may be selected to have an intermediate value. That is, it may be selected in such a way that an edit distance from other seeds in each seed cluster is the minimum.

In step S140, the representative seeds may be aligned relative to the reference sequence. The representative seeds may be aligned under a condition that a predetermined number of mismatching is allowed. In example embodiments, at least one of the representative seeds may be aligned to a plurality of positions of the reference sequence.

In step S150, the read sequences may be aligned with reference to the alignment of the representative seeds. The alignment result of the read sequences relative to the reference sequence may be output.

The read-sequence aligning method may be performed to group at least one seed produced from the read sequences into a plurality of seed clusters and perform an aligning process on only the representative seeds that are selected from the seed clusters, respectively. The read-sequence aligning method may be performed to avoid a duplicated calculation in consideration of similarity between the seeds, and this makes it possible to perform operations with efficiency.

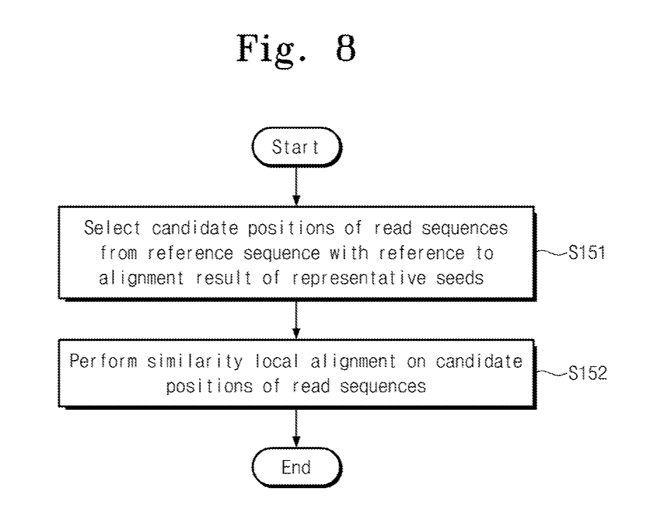

FIG. 8 is a flow chart exemplarily illustrating a method of aligning the read sequence with reference to a representative-seed mapping result shown in FIG. 7.

In step S151, the alignment result of the representative seeds may be referenced to select candidate positions of the read sequences relative to the reference sequence. For example, if there is a read sequence including two seeds that are contained in the first and second seed clusters, respectively, and are located within a predetermined distance, positions of unitial sequences, in which the first and second representative seeds are located within a predetermined distance, may be selected as the candidate positions for the read sequence. The number of the candidate positions for the read sequence may be varied in consideration of possibility of mismatching.

In step S152, a similarity local alignment of read sequences may be performed on the selected candidate positions of the read sequences. The similarity local alignment may be performed by comparing the read sequence with the remaining of the base sequences, except the aligned seed. The similarity local alignment may be calculated under a condition that a predetermined number of mismatching is allowed. For example, the similarity local alignment may be performed using Smith-Waterman algorithm. In example embodiments, the similarity local alignment may be calculated by scoring a degree of similarity. The read sequences may be aligned based on the result of the calculation. The aligned result may be output.

According to example embodiments of the inventive concept, a read sequence alignment may be performed using relationship between seeds, and thus, the sequencing may be performed with improved efficiency.

While example embodiments of the inventive concepts have been uniticularly shown and described, it will be understood by one of ordinary skill in the art that variations in form and detail may be made therein without deuniting from the spirit and scope of the attached claims. For example, the seed generating unit, the representative seed selecting unit, the seed aligning unit, the seed-information storing unit, and the read-sequence aligning unit may be variously modified depending on the user's needs and preference.

What is claimed is:

1. A read-sequence aligning apparatus, comprising:
a seed generating unit producing seeds from read sequences;
a representative seed selecting unit configured to group the seeds into a plurality of seed clusters and select representative seeds from each of the plurality of seed clusters;
a seed aligning unit aligning the representative seeds relative to a reference sequence; and
a read-sequence aligning unit aligning the read sequences relative to the reference sequence, with reference to the alignment result of the representative seeds.

2. The apparatus of claim 1, wherein the seed generating unit is configured to generate the seeds having a predetermined length.

3. The apparatus of claim 1, wherein the representative seed selecting unit is configured to group the seeds into the plurality of the seed clusters, on the basis of an edit distance.

4. The apparatus of claim 3, wherein the representative seed selecting unit groups the seeds, while the seeds in each seed cluster have an edit distance less than a predetermined critical value.

5. The apparatus of claim 4, wherein the predetermined critical value is 1.

6. The apparatus of claim 3, wherein the representative seed selecting unit is configured to select the representative seed from the plurality of the seed clusters, on the basis of the edit distance.

7. The apparatus of claim 6, wherein the selecting of the representative seed is performed in such a way that the representative seed for each seed cluster is selected to be one, having an intermediate value, of the seeds in each seed cluster.

8. The apparatus of claim 1, wherein the seed aligning unit is configured to align the representative seeds relative to the reference sequence, under a condition that a predetermined number of mismatching is allowed.

9. The apparatus of claim 1, further comprising a seed-information storing unit storing information on each of the seeds in the seed clusters,
wherein the information on each of the seeds comprises information on a position of a read sequence containing each of the seeds and information on a position of each of the seeds relative to the read sequence, and
the read-sequence aligning unit aligns the read sequences relative to the reference sequence, with reference to the information on each seed and an align result of the representative seeds.

10. A method of aligning a read-sequence, comprising:
generating seeds from read sequences;
grouping the seeds into a plurality of seed clusters;
selecting representative seeds from the seed clusters, respectively;
aligning the selected representative seeds relative to a reference sequence; and
aligning the read sequences relative to the reference sequence, with reference to the alignment result of the representative seeds.

11. The method of claim 10, wherein the grouping of the seeds is performed in such a way that the seeds in each seed cluster have an edit distance that is less than a predetermined critical value.

12. The method of claim 10, wherein the representative seeds is selected in such a way that an edit distance from other seeds in each seed cluster is the minimum.

13. The method of claim 10, wherein the aligning of the read sequences comprises:
selecting candidate positions of the read sequences with reference to the alignment result of the representative seeds; and
performing a similarity local alignment to the candidate positions of the read sequences,
wherein the similarity local alignment is calculated under a condition that a predetermined number of mismatching is allowed.

14. The method of claim 13, wherein the similarity local alignment is performed using Smith-Waterman algorithm.
